(19) United States
(12) Patent Application Publication
(10) Pub. No.: US 2026/0029386 A1
(43) Pub. Date: Jan. 29, 2026

(54) SYSTEM AND METHOD FOR CHROMATOGRAPHIC DATA REVIEW VIA ASSIGNMENT OF DISTANCES

(71) Applicant: Micromass UK Limited, Wilmslow (GB)

(72) Inventors: Matthew Frederick Wherry, Chapel-En-Le-Frith (GB); Richard Denny, Newcastle-under-Lyme (GB)

(73) Assignee: Micromass UK Limited, Wilmslow (GB)

(21) Appl. No.: 19/281,016

(22) Filed: Jul. 25, 2025

Related U.S. Application Data
(60) Provisional application No. 63/676,046, filed on Jul. 26, 2024.

(51) Int. Cl. G01N 30/86; G01N 30/02; G01N 30/72

(52) U.S. Cl. CPC G01N 30/8675; G01N 30/8631; G01N 30/8696; G01N 2030/027; G01N 30/7233

(57) ABSTRACT

The present technology relates to a method and instrument for quantifying and classifying a sample. The method collects raw data from an analytical instrument (e.g., LC-MS), determines statistical distances from a data distribution center for chromatographic peak features and/or MRM transition data, and ranks each chromatogram based on the determined statistical distances. The ranked chromatograms can be sorted to facilitate review of the chromatograms to exclude data that

### CROSS-REFERENCE TO RELATED APPLICATIONS

This application claims priority to U.S. Provisional Application Ser. No. 63/676,046 entitled “SYSTEM AND METHOD FOR CHROMATOGRAPHIC DATA REVIEW VIA ASSIGNMENT OF DISTANCES” filed Jul. 26, 2024, which is incorporated herein by reference in its entirety.

### FIELD OF THE TECHNOLOGY

The present disclosure relates to methods, techniques, and processes for validation of chromatographic data.

### BACKGROUND

Typical laboratory facilities are tasked with analyzing hundreds of samples each day. To ensure accuracy of all test results, the users of the analytical equipment have to continuously monitor the quality of the chromatograms that are produced. For example, users of the analytical equipment can spend up to about 10% of their time checking that certain statistics lie within acceptable ranges (usually in comparison to known standards). Up to 80% of the user's time can be spent manually reviewing each chromatogram to ensure the chromatogram accurately reflects the composition of the sample. There is a need to reduce the burden of manual chromatogram review by laboratory users while maintaining high levels of accuracy in testing facilities.

### SUMMARY

These unmet needs are addressed by the present instrument and method of chromatographic data validation. For example, present methods can be used to classify multiple chromatograms obtained from multiple samples having the same general composition. By applying Markov Chain Monte Carlo statistical analysis to the chromatograms, the chromatograms can be ranked and ordered based on a statistical “distance from consensus” measure. The ranking and ordering of chromatograms can improve manual review of the chromatograms by allowing the user to easily review the worst chromatograms until the chromatograms fall within the acceptable limits of the test.

In general, the present technology is directed to methods of interpretating collected instrument data. The method collects raw data from an analytical instrument (e.g., LC, MS, LC-MS), determines statistical distances from a data distribution center for chromatographic peak features and/or MRM transition data, and ranks each chromatogram based on the determined statistical distances. The ranked chromatograms can be sorted to facilitate review of numerous chromatograms to exclude data that is outside of an accepted tolerance for the analytical test. The present technology can address the challenges associated with manual review of chromatographic data.

In one aspect, the present technology is directed to a chromatographic instrument for quantifying analytes. The chromatographic instrument includes a processing device for executing computer readable instructions for performing a method of quantifying analytes. The method includes collecting chromatograms of one or more analytes of one or more samples; determining statistical distances with respect to a consensus data distribution for chromatographic peak features or MRM transition data of the collected chromatograms; and ranking each chromatogram based on the determined statistical distances.

The above aspect can include one or more of the following embodiments. In an embodiment, the statistical distances comprise one or more of: retention time (RT) distance with respect to a retention time consensus data distribution; full width, half maximum (FWHM) distance with respect to a FWHM consensus data distribution; peak area (PA) distance with respect to a peak area consensus data distribution; peak asymmetry (ASYM) distance with respect to a ASYM consensus data distribution; and peak height (PH) distance with respect to a PH consensus data distribution. In an embodiment, the chromatograms can be ranked based on a mathematical combination of a plurality of the statistical distances. In an embodiment, the statistical distances are calculated using a Markov Chain Monte Carlo (MCMC) method. In an embodiment, raw chromatographic data of the collected chromatograms are collected from a plurality of analytes that are run simultaneously or sequentially. In some embodiments, raw chromatographic data includes retention times and relative abundances. In an embodiment, the one or more samples comprise endogenous or isotopically labeled analytes. In an embodiment, the chromatographic instrument is a liquid chromatographic instrument. In some embodiments, the chromatographic instrument comprises a mass spectrometer.

In some embodiments, peak detection and ranking for chromatograms is based on variations in retention time and peak width. When analyzing MS data, ranking can be based on variations of peak height and peak area of the fragments of the sample generated during the MS process. The statistical “distances” are defined in terms of central estimates of these parameters in an ideal or average sample.

### BRIEF DESCRIPTION OF DRAWINGS

The technology will be more fully understood from the following detailed description taken in conjunction with the accompanying drawings, in which:

FIG. 1A depicts a simulated distribution of test points.

FIG. 1B depicts a GOOD classification of test points using a known Gaussian distribution.

FIG. 1C depicts a GOOD classification of test points using all points.

FIG. 1D depicts a Bayesian Markov Chain Monte Carlo method to explore GOOD/BAD states of a collection of test points.

FIG. 2 depicts a graphical representation of collected data with analyte everolimus and its isotopically labeled internal standard.

FIG. 3A depicts an analysis of the features of a chromatographic peak which are expected to vary significantly from one MRM transition to another of a particular precursor, consistently across a batch of samples or with pre-established parameters.

FIG. 3B depicts an analysis of the features of a chromatographic peak which are not expected to vary significantly from one MRM transition to another of a particular precursor.

FIG. 4 depicts an exemplary histogram of distances from the distribution center that can be used to rank chromatograms.

FIG. 5A shows an analysis of a first chromatogram identified in FIG. 4 as having one of the highest total distance scores.

FIG. 5B shows an analysis of a second chromatogram, identified as Peak 1 in FIG. 4, which has one of the highest total distance scores.

FIG. 5C shows an analysis of a third chromatogram identified in FIG. 4 as having one of the highest total distance scores.

FIG. 5D shows an analysis of a fourth chromatogram identified in FIG. 4 as having one of the highest total distance scores.

FIG. 6A shows an analysis of a first chromatogram identified in FIG. 4 as having a high total distance score.

FIG. 6B shows an analysis of a second chromatogram, identified as Peak 2 in FIG. 4, which has a high total distance score.

FIG. 6C shows an analysis of a third chromatogram identified in FIG. 4 as having a high total distance score.

FIG. 6D shows an analysis of a fourth chromatogram identified in FIG. 4 as having a high total distance score.

FIG. 7A shows an analysis of a first chromatogram, identified as Peak 3 in FIG. 4, which has a moderately high total distance score.

FIG. 7B shows an analysis of a second chromatogram, identified as Peak 4 in FIG. 4, which has a moderately high total distance score.

FIG. 7C shows an analysis of a third chromatogram identified in FIG. 4 as having a moderately high total distance score.

FIG. 7D shows an analysis of a fourth chromatogram identified in FIG. 4 as having a moderately high total distance score.

FIG. 8A depicts the area distance versus retention time distance.

FIG. 8B depicts the area distance versus peak FWHM distance.

FIG. 8C depicts the peak FWHM distance versus retention time distance.

FIG. 8D depicts a total distance versus posterior probability (Pr) of a peak being in the ON set.

FIG. 9 is a repeat of FIG. 8D, with the different sample types indicated.

FIG. 10A shows a chromatogram for a first standard peak indicated in FIG. 9 (circled).

FIG. 10B shows a chromatogram for a second standard peak indicated in FIG. 9 (ellipse).

FIG. 10C shows an internal standard chromatogram for comparison with the first and second standard peaks.

FIG. 11A shows a quantifier chromatogram.

FIG. 11B shows a chromatogram for the QC peak in FIG. 9 (square).

FIG. 11C shows an internal standard chromatogram for comparison with the QC peak.

### DETAILED DESCRIPTION

In general, the present technology is directed to a method and instrument for quantifying analytes in a sample. The method collects raw data from an analytical instrument (e.g., LC, MS, LC-MS), determines statistical distances from a consensus data distribution for chromatographic peak features or MRM transition data, and ranks each chromatogram based on the determined statistical distances. The ranked chromatograms can be sorted to facilitate review of numerous chromatograms to exclude data that is outside of an accepted tolerance for the analytical test. The present technology can address the challenges associated with manual review of chromatographic data.

In an example, the method collects raw chromatographic data from an analytical instrument. Preferably, the analytical instrument is a mass spectrometer (“MS”) or a liquid chromatography (LC) instrument.

In an example, the analytical instrument (e.g., MS or LC) from which raw data is collected also includes a processor that uses the sample classification method of the present technology. The instrument may collect a batch of samples/analytes either simultaneously or in sequence, which is advantageous given that the method is MRM-like, in that it may run multiple analyzes for multiple analytes. The analytical instrument may include a processing device for executing computer readable instructions for performing a method of quantifying analytes.

A method of quantifying analytes includes collecting chromatograms of one or more analytes of one or more samples. The chromatograms include raw (unprocessed) chromatographic data related to the analytes present in the sample. Once the raw chromatographic data is collected, peak detection is performed by using peak detection parameters.

In one embodiment, a ranking scheme is developed and used to rank the obtained chromatograms. In particular, the present technology may reduce the burden of manual chromatogram review on the user by employing a ranking scheme for chromatographic peaks from the raw chromatographic data. If the ranking scheme, which places chromatographic peaks in order from worst to best, is reliable, the measurements requiring adjustment or rejection should almost always appear above those that are immediately acceptable (i.e., semi-automated review). Additionally, components of statistical distance may be provided to aid interpretability of the ranking scheme. These components would reflect the degree of misfit of various aspects for the chromatographic peak measurement, e.g., consistency of retention time placement, peak width and peak area (including with respect to any ion ratio information). Given the ranking and separate components of distance, the user should quickly be able to assess the point at which further review is unnecessary.

The ranking scheme peak detection parameter may use one or more model parameters to optimize the ranking scheme. Examples of one or more model parameters include batch center, sample center (for each sample), compound center (for each compound, relative to the sample center), variation of transition measurements from compound center, overall variance scale for measurement, precursor abundances (one per compound), transition efficiencies (one for each transition), and overall variance scale for measurement.

Using estimates of model parameters,) a distance for each data point from the ideal is constructed. The estimates may be calculated at each iteration of an MCMC algorithm, and the squares of the distances averaged over the MCMC run to produce the final distances.

A Good-Bad data model approach is used to assign peaks either to an ON set governed by sub-model types A and B, or OFF data governed by sub-model type C. Type A for measurements of ON peaks, such as retention time or peak width, generally have no systematic variation between MRM transitions of a compound in particular sample. Type B for measurements of ON peaks is associated with abundance, such as peak height or area, that do have a systematic variation between MRM transitions of a compound in a particular sample (due to different efficiencies of the fragmentation of precursor to product). Type C model is used for all the attributes of OFF peaks. This may be a simple uniform model. Distances are defined in terms of central estimates of the parameters of the type A and type B models for peaks in the ON group.

Type A parameters that can be applied to data include: (1) batch center; (2) sample center (for each sample); (3) compound center (for each compound, relative to the sample center); (4) variation of transition measurements from the compound center; and (5) overall variance scale for measurement.

Type B parameters that can be applied to data include: (1) precursor abundances (one per compound); (2) transition efficiencies (one for each transition); and (3) overall variance scale for measurement.

Using estimates of these parameters a distance for each data point from the ideal can be constructed. The estimates may be calculated at each iteration of an MCMC algorithm, and the squares of the distances averaged over the MCM run to produce the final distances.

The analytes of the sample are not particularly limited in chemical structure. In an example, the analytes may be one or more endogenous peptides. Preferably, the analyte includes peptides from cellular samples that either contain disease state or are free of a disease state. The sample may contain internal standards from which feature information is inferred. In a preferred example, the sample includes isotopically labeled peptides.

The analytes of the sample can include biological analytes including peptides, nucleic acids, sugars, and lipids. Additional analytes of the samples include organic molecules, particularly organic compounds used for the treatment of physiological conditions and/or diseases.

Once a model is developed for a particular analyte, the method may be applied to other similar analytes. Purely as a quality check, experts may compare MRM chromatograms with their own manual interpretations to validate method results.

### Ranking Chromatographic Peak Measurements—Mahalanobis Distance

In one embodiment, Mahalanobis distance can be used to determine if a chromatographic peak is within the accepted tolerance of the analysis procedure (“GOOD”) or outside the accepted tolerance (BAD). Chromatograms with BAD data would be flagged for manual review based on a ranking score.

Mahalanobis distance is determined using a Gaussian sampling distribution of the data. Generally, the Mahalanobis distance is the distance of a test point from the center (e.g., the mean) of an elliptical or hyper-elliptical Gaussian distribution. The Mahalanobis distance can be calculated by determining the distance of a test point from the center and dividing by the width of the elliptical distribution along the direction of the test point from the center.

### Clustering Data With Outliers

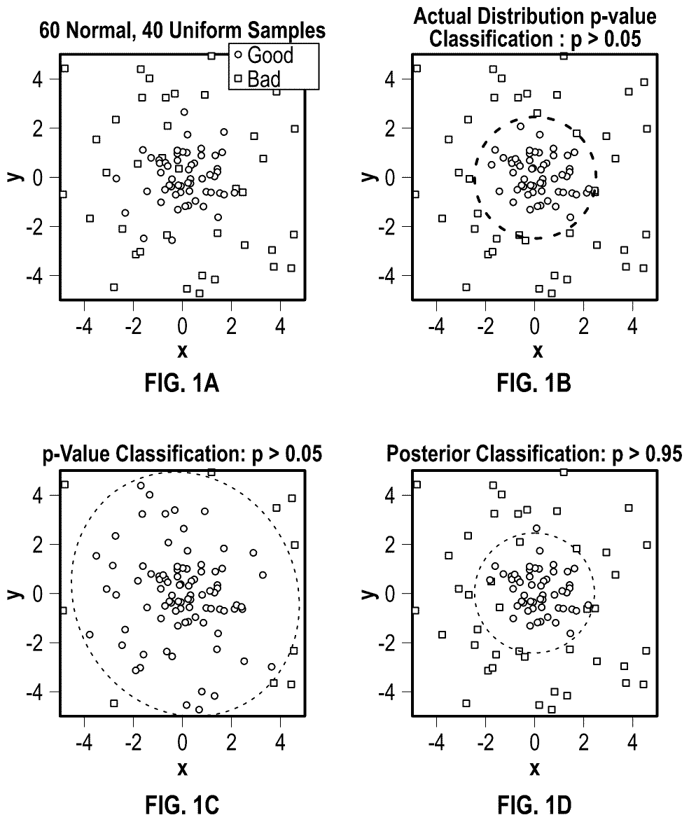

FIG. 1A depicts a simulated distribution of test points. In FIG. 1A, 40 BAD points are randomly drawn in a uniform 5×5 unit square, centered at (0,0). 60 GOOD points are also drawn randomly within a circularly symmetric Gaussian distribution with unit standard deviation, centered at (0,0). In FIG. 1B, the test points in the circle are classified as GOOD by using the know Gaussian distribution and selecting test points having a p-value of greater than 5%.

However, in many instances, the Gaussian distribution will not be known until after the data has been collected. In FIG. 1C, the Gaussian distribution is estimated from all of the data collected. The test points are then classified as GOOD by using the estimated Gaussian distribution and selecting test points having a p-value of greater than 5%. This leads to the inadvertent capture of BAD.

The problems associated with using an estimated Gaussian distribution can be ameliorated by use of a Bayesian Markov Chain Monte Carlo method to explore GOOD/BAD states of a collection of test points (FIG. 1D). Using posterior probability to classify the points (GOOD test points have a posterior probability of >95%), a selection of GOOD points can be achieved that is commensurate with the classification achieved using a known Gaussian distribution (FIG. 1B). While Bayesian methods are described herein, it should be understood that other outlier detection methods can be used.

### Application Example—Everolimus Immunosuppressant Data

Everolimus and its ¹³C₂²H₄ labelled internal standard were analyzed by LC-MS. Chromatography runs were made of analyte (Analyte*), calibrator 0, analyte (Analyte**) and solvent blank (Blank). The internal standard was subtracted from analyte measurements. Two features of the peaks in the chromatogram were studied. Peak width was used as a surrogate for what a user would inspect as a “peak shape.” In some embodiments, more than one measurement of peak width peak width (for example, at different heights) and measurements of peak asymmetry can be used to capture peak shape. For peak width measurements, the logarithm of peak width was used, so that an error-bar associated with peak width can be described in relative terms, e.g., a percentage. The logarithm for retention time was also used. However, retention time can also be used directly, since error-bar on measurement is not expected to change (e.g., increase) with increasing retention time.

TABLE 1

| | | | | Observed RT | | | |
|---|---|---|---|---|---|---|---|
| Injection | Product | Sample | Peak width_{—} | (min) | Posterior | Mahalanobis | |
| Name | (m/z) | Type | LOG_DIFF | LOG_DIFF | Probability | Distance | p-value |
| Run 18_005 | 926.5 | Blank | −0.693147181 | 0.026843951 | 0.001 | 7.092028 | 1.20E−11 |
| Run 18_012 | 926.5 | Analyte* | 0.006968669 | −0.020642071 | 0.01 | 5.811039 | 4.65E−08 |
| Run 18_002 | 926.5 | Analyte** | −0.693147181 | 0 | 0.196 | 3.990399 | 0.000349 |
| Run 18_002 | 908.5 | Analyte** | −0.521998924 | 0.013470542 | 0.284 | 3.903653 | 0.000491 |
| Run 18_005 | 908.5 | Blank | −0.627906659 | 0.006754153 | 0.422 | 3.516473 | 0.002065 |
| Run 18_012 | 908.5 | Analyte* | −0.337871817 | 0.013462876 | 0.589 | 3.451235 | 0.002592 |
| Run 18_001 | 926.5 | Analyte** | −0.580474018 | 0 | 0.533 | 3.370643 | 0.003411 |
| Run 18_003 | 908.5 | Analyte** | −0.460815203 | 0 | 0.853 | 2.713139 | 0.025209 |
| Run 18_007 | 908.5 | Standard | −0.10047053 | −0.006754153 | 0.966 | 2.314863 | 0.068611 |

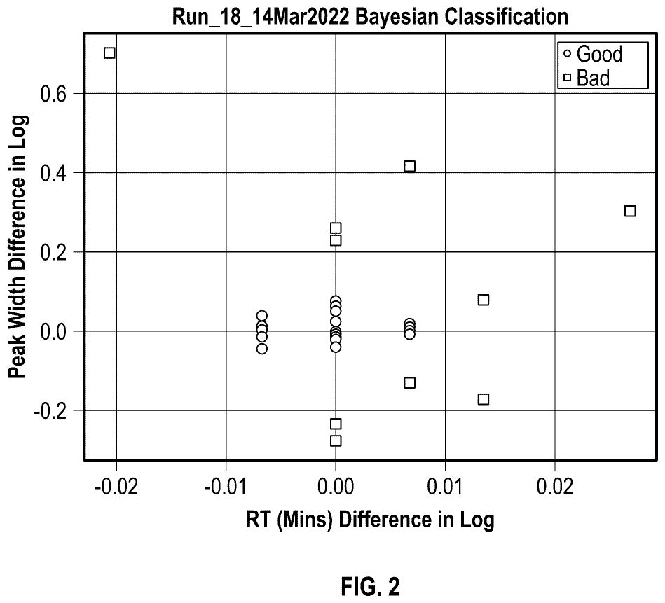

FIG. 2 depicts a graphical representation of the collected data. Table 1 shows calculated Mahalanobis distances on the basis of a Gaussian model for points weighted by posterior probability. The data show that, generally, distance decreases as posterior probability increases.

### Modifications to Improve Accuracy

The above-described model can be improved by additional modifications to the statistical analysis. For example, internal standard measurements may not be reliable. To improve accuracy, internal standards can be included in the full analysis. In another example, peak areas and/or ion ratios can be considered if multiple transitions have been acquired for a particular precursor. Inconsistent ratios between the quantifier and the qualifier ion area can be a sign of interference (e.g., a BAD chromatogram).

Additionally, batches of data will not always be available. In one embodiment, the method has the ability to learn from previous data. In one embodiment, the analysis can be primed from previous results or from a training set.

### Model Structure

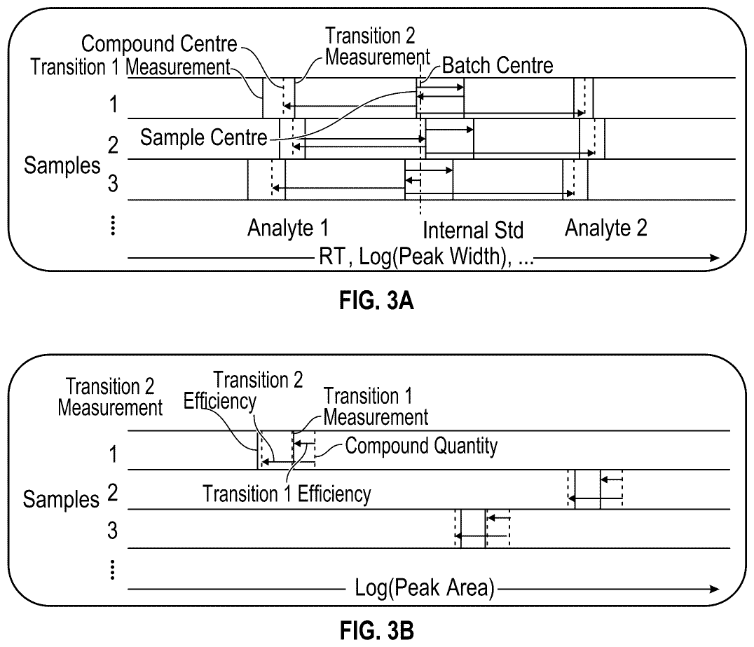

Data is split into “analytical groups.” An analytical group contains related compounds, often just a single compound of interest and its internal standard, across all samples in a batch. Two competing models can be used for each chromatographic peak in the group. ON: belongs to a “cluster” of peaks fitting well with requirements of RT alignment, peak width consistency, etc. OFF: could have come from anywhere in the measurement ranges, independently of other peaks. FIG. 3A depicts an analysis of chromatographic peaks.

Two types of measurements can be applied to mass spectroscopy data. “Positional” measurements are not expected to vary with MRM transition for a given compound, e.g., retention time, peak width. Peak width and peak asymmetry is part of what a user would consider about peak shape. “Quantity” expected to vary with MRM transition, e.g., peak area. FIG. 3B depicts an analysis of MRM transitions.

### Ranking of Chromatograms

Using the statistical methodology set forth herein, chromatograms can be ranked in descending order of a “distance from consensus” measure. After automatic ordering of the chromatograms by the software, a user will begin manually reviewing the ordered chromatograms. Once the chromatograms that are manually reviewed are considered to be within the accepted tolerance of the analysis procedure (“GOOD”), the manual review can be discontinued and the chromatograms that were not manually reviewed can be designated as GOOD. In some instances, greater than 50%, greater than 60%, greater than 70%, greater than 80%, or greater than 90% of the chromatograms can be designated as GOOD and excluded from manual review.

The statistical analytical methodology described herein can used for sample chromatograms as well as control chromatograms. The statistical analytical methodology can be applied to solvent blank chromatograms. Analysis of solvent blank chromatograms can indicate whether the reconstitution solvents are contaminated after passing through the column.

The statistical analytical methodology can be applied to double blank chromatograms. Analysis of double blank chromatograms can indicate whether the used matrices (e.g., plasma, serum, urine) are contaminated.

The statistical analytical methodology can be applied to single blank/QC-0 chromatograms (No Analyte/with Internal Standard). Analysis of single blank chromatograms can indicate whether the used internal standard (e.g., a stable isotope labelled standard) is contaminated. Blanks are studied because consistent (low distance) peaks in blanks may be a sign of problems, indicating carry-over or contamination. On the other hand, high distance peaks in blanks may still impinge upon the region of interest for a genuine analyte and so may also be of concern.

The method of ranking chromatograms is performed by determining statistical distances from a data distribution center for chromatographic peak features and/or MRM transition data. For example, statistical distances can be calculated based on one or more data points of the chromatogram. Data points that can be used to calculate statistical distances include, but are not limited to: retention time (RT) distance with respect to a RT consensus data distribution; full width, half maximum (FWHM) distance with respect to a FWHM consensus data distribution; peak area (PA) distance with respect to a PA data consensus data distribution; peak asymmetry (ASYM) distance with respect to a ASYM consensus data distribution; and peak height (PH) distance with respect to a PH consensus data distribution.

In one embodiment, the chromatograms are ranked based on the statistical distances that are calculated. The “highest” ranked chromatogram is the chromatogram with the highest calculated statistical distance. If multiple statistical distances were determined, the rank of the chromatogram is based on a mathematical combination of a plurality of the statistical distances. For example, the combined distances can be computed using as the Pythagorean distance (i.e., D²=d₁²+d₂²+ . . . dₙ² where D is the total statistical distance and dₙ is one of the individual statistical distances). The chromatogram with the highest mathematical combination of the statistical distances is given the highest rank. For example, the ranking of the chromatograms can be achieved by summing one or more of the RT distance, the FWHM distance, and the PA distance.

After the chromatograms are ranked, the chromatograms can be ordered (e.g., by sorting) sequentially, starting with the highest ranked chromatogram. Placing the highest ranked chromatograms in order places all the BAD chromatograms together. The ordered chromatograms are then reviewed sequentially, starting with the highest ranked chromatogram. As the review proceeds, the chromatograms will have progressively lower rankings, and will therefore be closer to GOOD chromatograms. Once the reviewer reaches the GOOD chromatograms, the review process can stop. The remaining, unreviewed chromatograms can be considered valid based on the low statistical distance from the ideal center of the distribution.

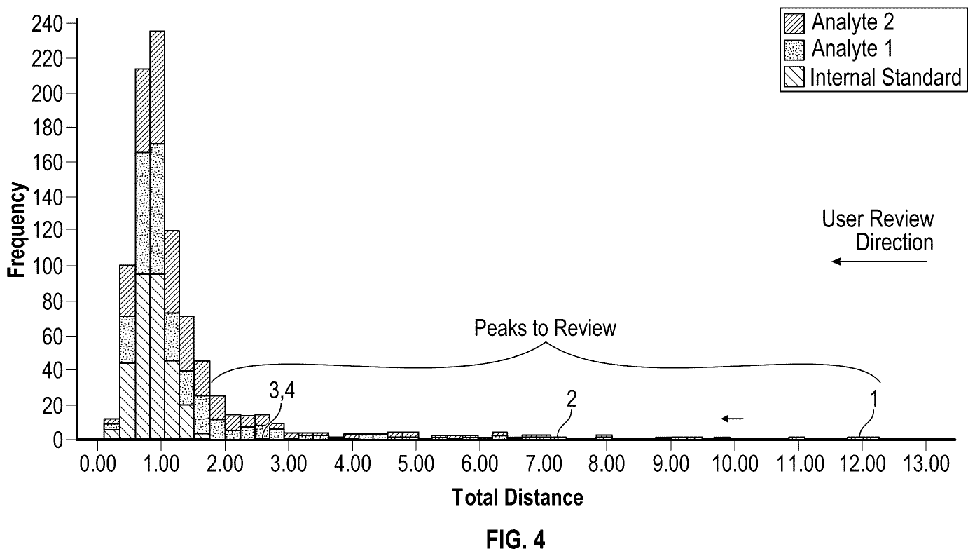

FIG. 4 depicts an exemplary histogram of distances from the consensus data distribution that can be used to rank chromatograms. In the example presented, an LC-MS chromatographic analysis is performed on a sample having an internal standard and two associated analytes (Analyte 1 and Analyte 2). After ranking the chromatograms based on total distance (based on the sum of the squares of the determined RT distance, FWHM distance, and PA distance) a sample section of the chromatograms is identified for manual review (designated as “Peak to review” in FIG. 4). Table 2 lists the total distance scores associated with peaks identified in FIG. 4 as Peaks 1-4.

TABLE 2

| | | | | | Distance | Distance | Distance | Distance | Total |
|---|---|---|---|---|---|---|---|---|---|
| Peak | RT | FWHM | ASYM | AREA | RT | FWHM | ASYM | AREA | Distance |
| 1 | 2.28 | 0.031 | 1.04 | 2322.97 | 0.05 | 7.61 | 1.35 | 9.40 | 12.17 |
| 2 | 2.28 | 0.030 | 1.03 | 3198.92 | 0.08 | 6.71 | 0.9 | 2.41 | 7.19 |
| 3 | 2.28 | 0.024 | 0.82 | 23577.19 | 0.09 | 0.59 | 0.91 | 2.31 | 2.56 |
| 4 | 2.28 | 0.025 | 0.87 | 7769.20 | 0.15 | 1.44 | 0.36 | 2.16 | 2.62 |

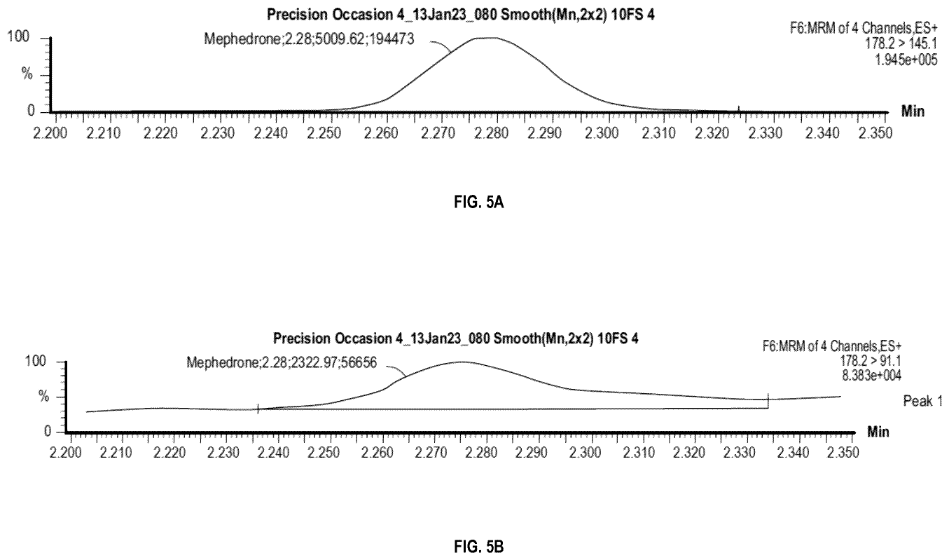

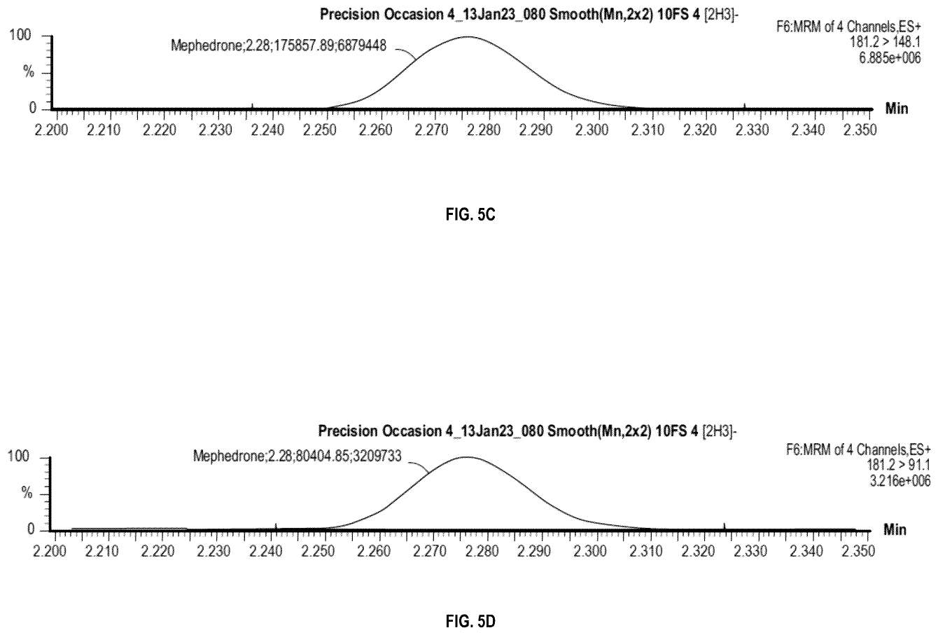

FIGS. 5A-5D show an analysis of four different chromatograms identified as having the highest total distance scores (total distance greater than 10). FIG. 5B shows the chromatogram associated with Peak 1 (identified in FIG. 4) is wide and its area ratio is high compared with normal peaks.

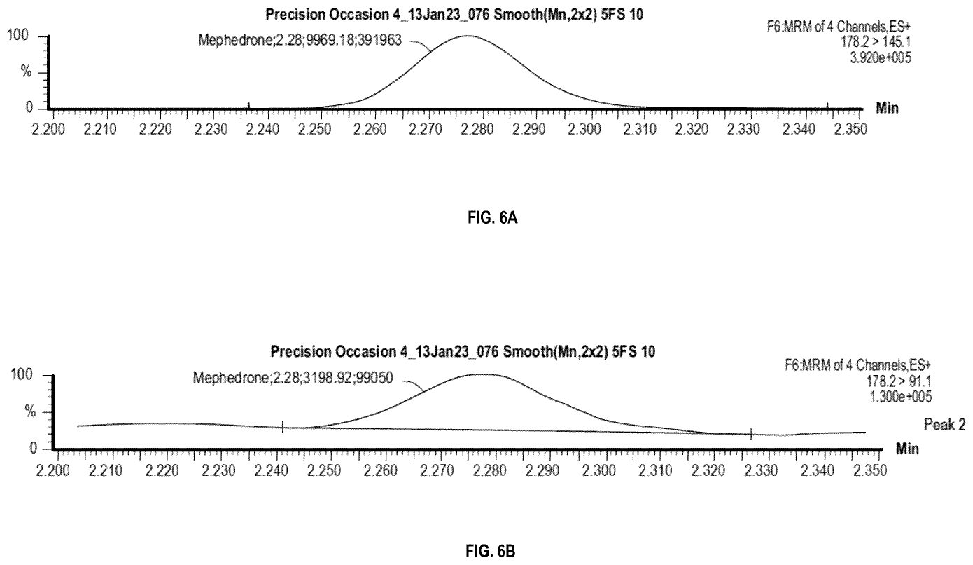

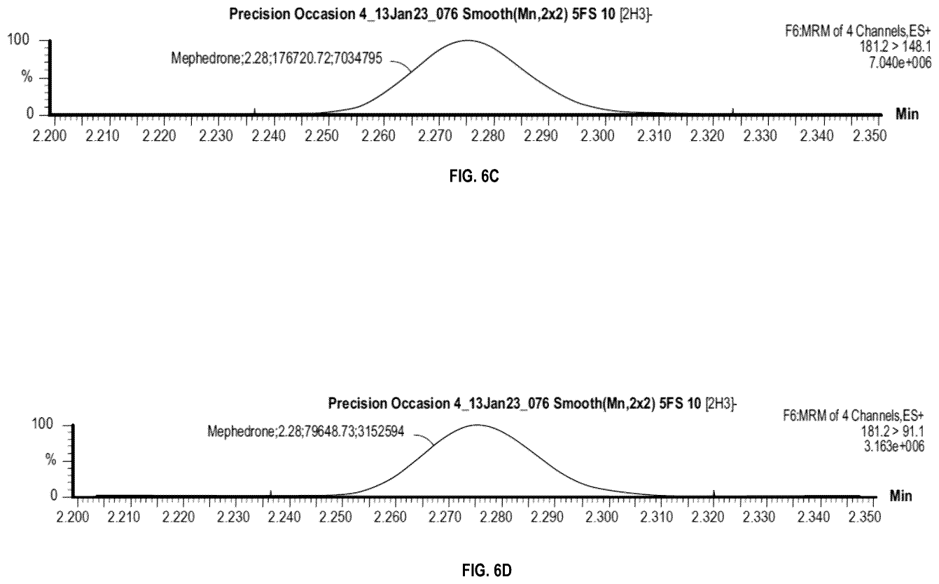

FIGS. 6A-6D shows an analysis of four different chromatograms identified as having high total distance scores (total distance less than 10, greater than 5). FIG. 6B shows the Peak 2, which also has a relatively high total distance score. FIG. 6B shows the chromatogram associated with Peak 2 (identified in FIG. 4) is wide and also includes an impurity having an earlier retention time.

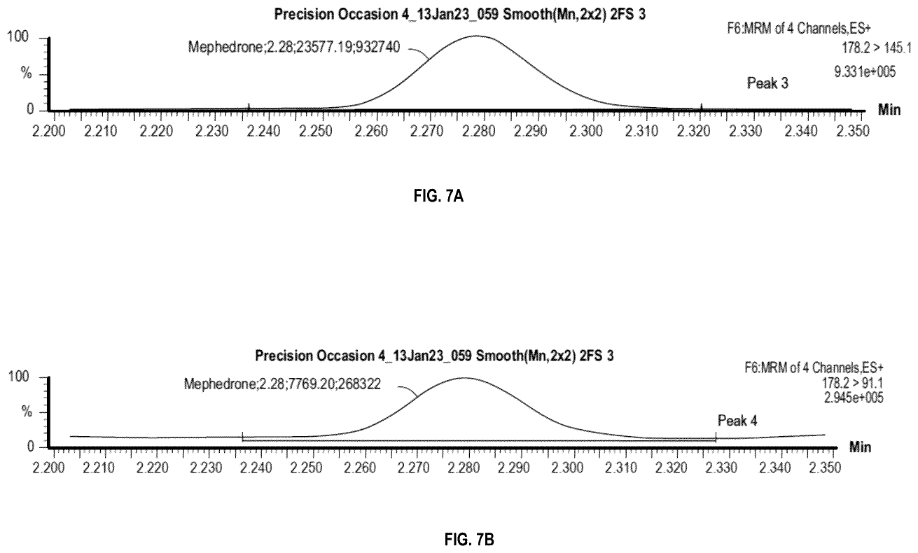

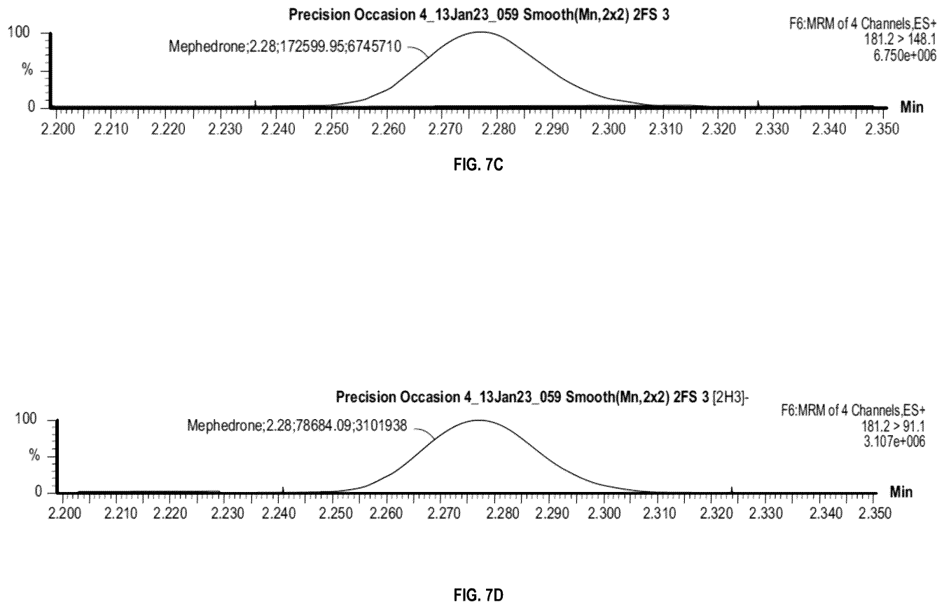

FIGS. 7A-7D shows an analysis of four different chromatograms identified as having moderately high total distance scores (total distance less than 5, greater than 1). Although Peak 3 (FIG. 7A) and Peak 4 (FIG. 7B) have consistent shapes, the area ratio between the peaks is a little high.

### MCMC Statistical Model of Distance Measurements

It is assumed that set of compounds analyzed in a particular batch of samples is broken down into analytical groups. Usually, a group will contain a single internal standard and a common use-case has groups comprising a single analyte compound and its isotopically labelled version as the internal standard. The analysis of the analytical groups is taken to be independent.

There are K samples to analyze for which there are Jᵢ transitions for the i^{th} compound in the analytical group.

Each measurement dimension can be considered independently, e.g., retention time, so that xᵢⱼₖ refers to the measured retention time of the j^{th} transition for the i^{th} com-pound in the analytical group. The possible range of measurements is taken to have size Δ.

The position might vary with sample, so the central position μₖ for the com-pounds in a single sample can be allowed to be distributed around some global central position v.

There might be systematic differences between the different compounds in the analytical group which can be modeled as a shift δμᵢ, so that we expect xᵢⱼₖ≈μₖ+δμᵢ for I, j in the acquired set of transitions.

Ion areas and ratios are treated slightly differently as there are a set of transition efficiencies associated with a compound which are scaled by a quantity of the compound in a particular sample.

The aim is to produce a system that will provide “distances” for each measurement from some central estimate and probabilities of “goodness”, i.e., of the measurement belonging to a consensus of good measurements. This consensus might come from the analysis of an individual batch or may also be influenced by historical/training data from previous acquisitions.

The analysis can be divided into two parts:
1. Those measurements which are expected to be invariant (within statistical error) across MRM transitions of the same precursor ion but may have systematic differences from sample to sample or compound to compound, e.g., retention time and peak width. These are call positional measurements due to their similarity to retention time (position along the x-axis) in this respect.
2. Those measurements which are expected to be invariant (within statistical error) across samples and compounds but have systematic differences across MRM transitions of the same precursor ion, e.g., peak area. These are called quantity measurements.

### Completing the Square and Marginalization

Given a quadratic expression, Aθ²−2Bθ+C, we may “complete the square” to give

$$A {θ}^{2} - 2 B θ + C = {A ( θ - \frac{B}{A} )}^{2} - \frac{{B}^{2}}{A} - C . \qquad ( 1 )$$

In the following, we frequently encounter Gaussian joint probabilities of the form

$$Pr ( θ , data \vert context ) ∝ exp [ - \frac{1}{2} ( A {θ}^{2} - 2 B θ + C ) ] = exp [ - \frac{1}{2} ( {A ( θ - \frac{B}{A} )}^{2} - \frac{{B}^{2}}{A} + C ) ] \qquad ( 2 )$$

Marginalizing out θ involves taking the integral of the joint probability over some prior range Δ. The range may be infinite or large enough to justify approximating the result by integrating over infinite range,

$$Pr ( θ , data \vert context ) = {\int }_{Δ} Pr ( θ , data \vert context ) d θ \approx {\int }_{- ∞}^{+ ∞} Pr ( θ , data ) d θ ∝ \sqrt{\frac{2 π}{A}} exp [ - \frac{1}{2} ( C - \frac{{B}^{2}}{A} ) ] . \qquad ( 3 )$$

The central estimate

$$\hat{θ} = \frac{B}{A} \pm {A}^{- \frac{1}{2}}$$

(mean±1 standard deviation) may also be use-ful.
The scalar θ might be upgraded to N-dimensional vector θ with matrix A, vector b and scalar C, so that

$${θ}^{T} A θ - 2 {θ}^{T} b + C = {( θ - {A}^{- 1} b )}^{T} A ( θ - {A}^{- 1} b ) - {b}^{T} {A}^{- 1} b + C . \qquad ( 4 )$$

Marginalisation then yields

$$\begin{matrix}Pr ( data \vert context ) = & & {\int }_{Δ} Pr ( θ , data \vert context ) d θ \\ ∝ & \sqrt{\frac{{( 2 π )}^{N}}{det ( A )}} & exp [ - \frac{1}{2} ( C - {b}^{T} {A}^{- 1} b ) ] .\end{matrix} \qquad ( 5 )$$

The central estimate \hat{θ}θ=A⁻¹b has covariance A⁻¹. Actually, the inverse A⁻¹ need not be calculated if covariances are not required; as A is symmetric and positive definite (a benefit of having proper priors), we may use Cholesky decomposition to find the lower triangular matrix L such that LL^{T}=A. It is easy to solve the triangular system of equations Lx=b to find x=L⁻¹b, so that b^{T} A⁻¹b=b^{T} L^{-T} L⁻¹b=x·x. The central estimate \hat{θ}θ=A⁻¹b=L^{-T} x is the solution to the (upper) triangular system of equations L^{T} \hat{θ}θ=x.

### Markov Chain Monte Carlo

The switch states controlling the OFF/ON status of each measurement are explored using Markov Chain Monte Carlo (MCMC) techniques, as are the various variances associated the prior positional and quantity centers.

The switch states may be sampled using Gibbs sampling, where a new state (which may be the same as the old state) is simply sampled from the prior probability distribution for OFF/ON for the particular sample and compound combination. The ON state may be subdivided to select a particular chromatographic peak if more than one has been measured in a particular chromatogram.

For the variances, we require a prior probability distribution which is positive only in (0, ∞). An effective technique for exploring these parameters is slice sampling for which convenient priors have an easily invertible cumulant. One way to achieve both these requirements is to use a logistic prior on the logarithm of the standard deviation, for example,

$$Pr ( log σ \vert ξ , Ϛ ) d log σ = {( \frac{1}{2 Ϛ} sech ( \frac{log σ - ξ}{2 Ϛ} ) )}^{2} d log σ . \qquad ( 6 )$$

so that a sample is obtained from some r˜ Uniform (0, 1) by

$$log σ = Ϛ log ( \frac{r}{1 - r} ) + ξ . \qquad ( 7 )$$

Here ξ is the mean, median and mode of the logistic distribution while the scale parameter ζ may be set by choosing the values of particular quantiles or choosing a standard deviation equal to

$$\frac{π ζ}{\sqrt{3}}$$

The logistic distribution has heavier tails than a normal distribution with the same standard deviation which might be advantageous in the context of MCMC exploration.

A simple MCMC implementation would sample a state for the entire system from the combined prior and then allow the state to evolve through a series of transitions, each obeying detailed balance. One iteration of this simple method might involve sampling all the parameters, accepting new states if they meet or exceed a log-likelihood threshold, log L*, set at the start of the iteration as

$$log {L}^{*} = log L + log Uniform ( 0 , 1 ) . \qquad ( 8 )$$

For a number of “burn-in” iterations no statistics are collected from the samples to give time for the state to evolve into the so-called “posterior bubble”. Thereafter, statistics on any quantity of interest may be accumulated until a sufficient number of samples has been acquired. In the present context, we are mainly interested in accumulating the posterior probabilities of the switch states and squared distances of the measurements from current central model. We may also acquire statistics relating to the model, perhaps to inform the setting of priors for subsequently analyzed data.

### Positional Measurements

Positional measurements, such as retention time, peak width or peak asymmetry, where the expected value does not vary between different MRM transitions of the same precursor ion, may be transformed to a convenient axis. For retention time the most convenient axis is probably the original measurement axis, e.g., minutes, as the error-bar on the measurement is assumed not to vary with retention time. For peak width, on the other hand, the error-bar on a measurement is assumed to be approximately proportional to the value of the measurement. In this case the logarithm is used as δ

$$log x \approx \frac{δ x}{x}$$

for small δ log x.

### Prior Probability Distributions

The width parameters of distributions are given relative to some single underlying scale κ which may be marginalized away later.

### Global Central Position

$$Pr ( v \vert η , κ ) dv = {( 2 {πη}^{2} {κ}^{2} )}^{- \frac{1}{2}} exp [ - \frac{1}{2 {κ}^{2}} \frac{{( v - {v}_{0} )}^{2}}{{η}^{2}} ] dv \qquad ( 9 )$$

### Sample Central Position

$$Pr ( {μ}_{k} \vert v , τ , κ ) d {μ}_{k} = {( 2 π {τ}^{2} {κ}^{2} )}^{- \frac{1}{2}} exp [ - \frac{1}{2 {κ}^{2}} \frac{{( {μ}_{k} - v )}^{2}}{{τ}^{2}} ] d {μ}_{k} \qquad ( 10 )$$

### Global Positional Offset of a Compound

$$Pr ( {δμ}_{i} \vert γ , κ ) d {δμ}_{i} = {( 2 {πγ}^{2} {κ}^{2} )}^{- \frac{1}{2}} exp [ - \frac{1}{2 {κ}^{2}} \frac{{( {δμ}_{i} - δ {μ}_{0 i} )}^{2}}{{γ}^{2}} ] d {δμ}_{i} \qquad ( 11 )$$

### Likelihood

$$Pr ( {x}_{ijk} \vert {μ}_{k} , {δμ}_{i} , σ , κ ) = {( 2 {πσ}^{2} {κ}^{2} )}^{- \frac{1}{2}} exp [ - \frac{1}{2 {κ}^{2}} \frac{{( {x}_{ijk} - {μ}_{k} - {δμ}_{i} )}^{2}}{{σ}^{2}} ] \qquad ( 12 )$$

### Analysis

Given the prior probability distributions and likelihood functions, we could allow the MCMC to sample all the parameters involved. However, with some effort, we may marginalize out some parameters in advance, thereby making the MCMC more efficient.

### Step 1: Marginalize Out the μₖ

Firstly, let yᵢⱼₖ=xᵢⱼₖ−δμᵢ. Now set up the joint probability with the data

$$Pr ( {μ}_{k} , {\{ {𝓎}_{ijk} \}}_{k} \vert v , \{ {δμ}_{i} \} , τ , σ , κ ) = {( 2 π {r}^{2} {κ}^{2} )}^{- \frac{1}{2}} {( 2 π {r}^{2} {κ}^{2} )}^{- \frac{1}{2}} {( 2 {πσ}^{2} {κ}^{2} )}^{- \frac{{N}_{k}}{2}} exp [ - \frac{1}{2 {κ}^{2}} ( \frac{{( {μ}_{k} - v )}^{2}}{{τ}^{2}} + \frac{{\sum }_{ij} {( {𝓎}_{ijk} - {μ}_{k} )}^{2}}{{σ}^{2}} ) ] . \qquad ( 13 )$$

The number of transitions for the i^{th} compound in the ON set for sample k is Nᵢₖ. Rearranging the exponent,

$$\begin{matrix}\frac{{( {μ}_{k} - v )}^{2}}{{τ}^{2}} + \frac{{\sum }_{ij} {( {𝓎}_{ijk} - {μ}_{k} )}^{2}}{{σ}^{2}} = & ( {τ}^{- 2} + {σ}^{- 2} {\sum }_{i} {N}_{ik} ) {( {μ}_{k} - \frac{v {τ}^{- 2} + {σ}^{- 2} {\sum }_{i} {N}_{ik} {\ddot{𝓎}}_{ik}}{{τ}^{- 2} + {σ}^{- 2} {\sum }_{i} {N}_{ik}} )}^{2} \\ & - \frac{{( v {τ}^{- 2} + {σ}^{- 2} {\sum }_{i} {N}_{ik} {\overline{𝓎}}_{ik} )}^{2}}{{τ}^{- 2} + {σ}^{- 2} {\sum }_{i} {N}_{ik}} \\ & + {v}^{2} {τ}^{- 2} + {σ}^{- 2} {\sum }_{i} {N}_{ik} {𝓎}_{ik}^{{}^{-} 2} ,\end{matrix} \qquad ( 14 )$$

$$where {\ddot{𝓎}}_{ik} = {N}_{ik}^{- 1} {\sum }_{j} {𝓎}_{ijk} and {𝓎}_{ik}^{{}^{-} 2} = {N}_{ik}^{- 1} {\sum }_{j} {𝓎}_{ijk}^{2} .$$

Now perform the marginalisation, letting Nₖ=ΣᵢNᵢₖ and ΣᵢNᵢₖy̅ᵢₖ=Nₖy̅ₖ,

$$\begin{matrix}Pr ( \{ {𝓎}_{ijk} \} k \vert v , \{ {δμ}_{i} \} , τ , σ , κ ) = {( \frac{{σ}^{2}}{{τ}^{2} {N}_{k} + {σ}^{2}} )}^{\frac{1}{2}} {( 2 {πσ}^{2} {κ}^{2} )}^{- \frac{{N}_{k}}{2}} \\ exp [ - \frac{1}{2 {κ}^{2}} \frac{{N}_{k} \overline{{𝓎}_{k}^{2}}}{{σ}^{2}} ] \\ exp [ - \frac{1}{2 {κ}^{2}} ( {v}^{2} {τ}^{- 2} - \frac{{( v {τ}^{- 2} + {σ}^{- 2} {N}_{k} {\ddot{𝓎}}_{k} )}^{2}}{{τ}^{- 2} + {σ}^{- 2} {N}_{k}} ) ] .\end{matrix} \qquad ( 15 )$$

Taking the product over K samples, with N=ΣₖNₖ,

$$\begin{matrix}Pr ( \{ {y}_{ij k} \} \vert v , \{ {δμ}_{i} \} , τ , σ , κ ) = & [ {\prod }_{k} {( \frac{{σ}^{2}}{{τ}^{2} {N}_{k} + {σ}^{2}} )}^{\frac{1}{2}} ] {( 2 π {σ}^{2} {κ}^{2} )}^{- \frac{N}{2}} \\ & exp [ - \frac{1}{2 {κ}^{2}} \frac{{\sum }_{k} {N}_{k} {y}_{k}^{{}^{-} 2}}{{σ}^{2}} ] \\ & exp [ - \frac{1}{2 {κ}^{2}} {\sum }_{k} ( {v}^{2} {τ}^{- 2} - \frac{{( v {τ}^{- 2} + {σ}^{- 2} {N}_{k} {\overline{y}}_{k} )}^{2}}{{τ}^{- 2} + {σ}^{- 2} {N}_{k}} ) ]\end{matrix} \qquad ( 16 )$$

### Step 2: Marginalize Out v

Examining the same in the second exponential above, we bare

$$\begin{matrix}{\sum }_{k} ( {v}^{2} {τ}^{- 2} - \frac{{( v {τ}^{- 2} + {σ}^{- 2} {N}_{k} {\overline{y}}_{k} )}^{2}}{{σ}^{- 2} {N}_{k} + {τ}^{- 2}} ) = & {v}^{2} {\sum }_{k} \frac{{N}_{k}}{{N}_{k} {τ}^{2} + {σ}^{2}} \\ & - 2 v {\sum }_{k} \frac{{N}_{k} {\overline{𝓎}}_{k}}{{N}_{k} {τ}^{2} + {σ}^{2}} \\ & - {τ}^{2} {σ}^{- 2} {\sum }_{k} \frac{{( {N}_{k} {\overline{y}}_{k} )}^{2}}{{N}_{k} {τ}^{2} + {σ}^{2}}\end{matrix} \qquad ( 17 )$$

$$Define ,$$

$$\begin{matrix}W = & {\sum }_{k} \frac{{N}_{k}}{{N}_{k} {τ}^{2} + {σ}^{2}} \\ {S}_{y} = & {\sum }_{k} \frac{{N}_{k} {\overline{y}}_{k}}{{N}_{k} {τ}^{2} + {σ}^{2}} \\ {S}_{yy} = & {τ}^{2} {σ}^{- 2} {\sum }_{k} \frac{{( {N}_{k} {\overline{y}}_{k} )}^{2}}{{N}_{k} {τ}^{2} + {σ}^{2}} .\end{matrix} \qquad ( 18 )$$

On introducing the Gaussian prior the sum becomes.

$$\begin{matrix}{\sum }_{k} ( {v}^{2} {τ}^{- 2} - \frac{{( v {τ}^{- 2} + {σ}^{- 2} {N}_{k} {\overline{y}}_{k} )}^{2}}{{σ}^{- 2} {N}_{k} + {τ}^{- 2}} ) + {{η}^{- 2} ( v - {v}_{0} )}^{2} = {v}^{2} ( {η}^{- 2} + W ) \\ - 2 v ( {η}^{- 2} {v}_{0} + {S}_{y} ) \\ + ( {η}^{- 2} {v}_{0}^{2} - {S}_{yy} )\end{matrix} \qquad ( 19 )$$

Marginalisation now yields,

$$\begin{matrix}Pr ( \{ {y}_{ijk} \} , v \vert \{ δ {μ}_{i} \} , {v}_{0} , η , τ , σ , κ ) = {[ W {η}^{2} + 1 ]}^{- \frac{1}{2}} [ {\prod }_{k} {( \frac{{σ}^{2}}{{τ}^{2} {N}_{k} + {σ}^{2}} )}^{\frac{1}{2}} ] {( 2 {πσ}^{2} {κ}^{2} )}^{- \frac{N}{2}} \\ exp [ - \frac{1}{2 {κ}^{2}} \frac{{\sum }_{k} {N}_{k} {y}_{k}^{{}^{-} 2}}{{σ}^{2}} ] \\ exp [ - \frac{1}{2 {κ}^{2}} ( {η}^{- 2} {v}_{0}^{2} - {S}_{yy} - \frac{{( {η}^{- 2} {v}_{0} + {S}_{y} )}^{2}}{{η}^{- 2} + W} ) ] .\end{matrix} \qquad ( 20 )$$

We was define get more quantities to simplify the notation:

$${w}_{k} = \frac{{N}_{k}}{{N}_{k} {τ}^{2} + {σ}^{2}} \qquad ( 21 )$$

$$with W = {\sum }_{k} {w}_{k} ,$$

$${( \overline{y} )}_{w} = {W}^{- 1} {\sum }_{k} {w}_{k} {\overline{y}}_{k} , < {y}^{{}^{-} 2} {>}_{w} = {W}^{- 1} {\sum }_{k} {w}_{k} {y}_{k}^{{}^{-} 2} , \qquad ( 22 )$$

$$and$$

$$Var [ y ] = {y}^{{}^{-} 2} - {\overline{y}}^{2} . \qquad ( 23 )$$

We can now rewrite the terms in the exponents above as

$$\begin{matrix}\frac{{\sum }_{k} {N}_{k} {y}_{k}^{{}^{-} 2}}{{σ}^{2}} + {η}^{- 2} {v}_{0}^{2} - {S}_{yy} - \frac{{( {η}^{- 2} {v}_{0} + {S}_{y} )}^{2}}{{η}^{- 2} + W} = \frac{{\sum }_{k} {N}_{κ} {Var [ y ]}_{k}}{{σ}^{2}} \\ + W ( < {y}^{{}^{-} 2} {>}_{w} - {( < \overline{y} > )}_{w}^{2} ) \\ + \frac{W {( {v}_{0} - < \overline{y} {>}_{w} )}^{2}}{W {η}^{2} + 1}\end{matrix} \qquad ( 24 )$$

### Step 3: Marginalize Out the δμᵢ

The δμᵢ are bidden in the y̅ₖ and y̅²̅ₖ terms above. Restating with the δμᵢ explicit we have,

$$W ( < {y}^{{-}^{} 2} {>}_{w} - ( < \overline{y} {>}_{w}^{2} ) = {\sum }_{k} {\sum }_{i} {w}_{ik} \overline{{( {x}_{ijk} - δ {μ}_{i} )}^{2}} - {{W}^{- 1} [ {\sum }_{k} {\sum }_{i} {w}_{ik} ( {\overline{x}}_{ik} - {δμ}_{i} ) ]}^{2} , \qquad ( 25 )$$

$$where {w}_{ik} = \frac{{N}_{jk}}{{N}_{k} {τ}^{2} + {σ}^{2}} , and$$

$${N}_{k} {Var [ y ]}_{k} = {\sum }_{i} {N}_{ik} \overline{{( {x}_{ijk} - δ {μ}_{i} )}^{2}} - {{N}_{k}^{- 1} [ {\sum }_{i} {N}_{ik} ( {\overline{x}}_{ik} - {δμ}_{i} ) ]}^{2} . \qquad ( 26 )$$

Using the notation

$$\begin{matrix}< \overline{x} {>}_{w} = {W}^{- 1} {\sum }_{i} {\sum }_{k} {w}_{ik} {\ddot{x}}_{ik} \\ < {x}^{{}^{-} 2} {>}_{w} = {W}^{- 1} {\sum }_{i} {\sum }_{k} {w}_{ik} {x}_{ik}^{{}^{-} 2} \\ < {\overline{x}}_{i} {>}_{wi} = {W}_{i}^{- 1} {\sum }_{k} {w}_{ik} {\overline{x}}_{ik}\end{matrix} \qquad ( 27 )$$

for Wᵢ=Σₖ ωᵢₖ at fixed i, and the fact that

$${\overline{y}}_{k} = {N}_{k}^{- 1} {\sum }_{i} {N}_{ik} ( {\overline{x}}_{ik} - {δ}_{{μ}_{i}} ) \qquad ( 28 )$$

we have,

$$\begin{matrix}W ( < {y}^{{}^{-} 2} {>}_{w} - < \overline{y} {>}_{w}^{2} ) = W ( < {x}^{{}^{-} 2} {>}_{w} - < \overline{x} {>}_{w}^{2} ) \\ - 2 {\sum }_{i} {δμ}_{i} {W}_{i} ( < {\overline{x}}_{i} {>}_{{w}_{i}} - < \overline{x} {>}_{w} ) \\ + {W}^{- 1} {\sum }_{i} {W}_{i} {δμ}_{i} ( {\sum }_{{i}^{′}} {w}_{{i}^{′}} ( {δμ}_{i} - {δμ}_{{i}^{′}} ) ) ,\end{matrix} \qquad ( 29 )$$

$$while$$

$$\begin{matrix}{\sum }_{k} {N}_{k} {Var [ y ]}_{k} = {\sum }_{k} {N}_{k} ( {x}_{k}^{{}^{-} 2} - {x}_{k}^{{}^{-} 2} ) \\ - 2 {\sum }_{i} {δμ}_{i} {\sum }_{k} {N}_{ik} ( {\overline{x}}_{ik} - {\overline{x}}_{k} ) \\ + {\sum }_{i} {δμ}_{i} {\sum }_{k} {N}_{k}^{- 1} {N}_{ik} ( {\sum }_{{i}^{′}} {N}_{{i}^{′} k} ( {δμ}_{i} - {δμ}_{{i}^{′}} ) ) .\end{matrix} \qquad ( 30 )$$

$$Also ,$$

$${S}_{y} = {\sum }_{k} {\sum }_{i} {w}_{ik} ( {\overline{x}}_{ik} - {δμ}_{i} ) = W < \overline{y} {>}_{w} = {S}_{x} - {\sum }_{i} {\sum }_{k} {w}_{ik} {δμ}_{i} , \qquad ( 31 )$$

$$where$$

$${S}_{x} = {\sum }_{k} {w}_{ik} {\overline{x}}_{ik} = W < \overline{x} {>}_{w} , \qquad ( 32 )$$

$${S}_{y}^{2} = {S}_{x}^{2} - 2 {S}_{x} {\sum }_{i} {δμ}_{i} {\sum }_{k} {w}_{ik} + {\sum }_{i} {\sum }_{{i}^{′}} {δμ}_{i} {δμ}_{{i}^{′}} {\sum }_{k} {w}_{ik} {\sum }_{k} {w}_{{i}^{′} {k}^{′}} . \qquad ( 33 )$$

Including the prior and expressing in matrix-vector form we have,

$${A}_{i , {i}^{′}} = \{ \begin{matrix}{W}_{i} - {{η}^{2} ( W {η}^{2} + 1 )}^{- 1} {W}_{i}^{2} \\ + {σ}^{- 2} {\sum }_{k} ( {N}_{ik} - {N}_{k}^{- 1} {N}_{ik}^{2} ) + {γ}^{- 2} \\ - {{η}^{2} ( W {η}^{2} + 1 )}^{- 1} {W}_{i} {W}_{{i}^{′}} \\ - {σ}^{- 2} {\sum }_{k} {N}_{k}^{- 1} {N}_{ik} {N}_{{i}^{′} k}\end{matrix} \begin{matrix}, i = {i}^{′} \\ \\ , i \neq {i}^{′}\end{matrix} , \qquad ( 34 )$$

$${b}_{i} = {σ}^{- 2} {\sum }_{k} {N}_{ik} ( {\overline{x}}_{ik} - {\overline{x}}_{k} ) + {W}_{i} ( {( {\overline{x}}_{i} )}_{wi} - {( \overline{x} )}_{w} ) + {W}_{i} ( \frac{< \overline{x} {>}_{w} - {v}_{0}}{W {η}^{2} + 1} ) + {γ}^{- 2} {δμ}_{0 i} , \qquad ( 35 )$$

$$C = {σ}^{- 2} {\sum }_{k} {N}_{k} ( {x}_{k}^{{}^{-} 2} - {\overline{x}}_{k}^{2} ) + W ( < {x}^{{}^{-} 2} {>}_{w} - {( < \overline{x} > )}_{w}^{2} ) + W \frac{{( < \overline{x} {>}_{w} - {v}_{0} )}^{2}}{( W {η}^{2} + 1 )} + {γ}^{- 2} {\sum }_{i} {δμ}_{0 i}^{2} . \qquad ( 36 )$$

Marginalization yields,

$$\begin{matrix}Pr ( \{ {x}_{ijk} \} \vert \{ {δμ}_{0 i} \} , γ , {v}_{0} , η , τ , σ , κ ) = {γ}^{- 1} det {{( A )}^{- \frac{1}{2}} [ W {η}^{2} + 1 ]}^{- \frac{1}{2}} \\ {[ {\prod }_{k} ( \frac{{τ}^{2} {N}_{k} + {σ}^{2}}{{σ}^{2}} ) ]}^{- \frac{1}{2}} \\ {( 2 π {σ}^{2} {κ}^{2} )}^{- \frac{N}{2}} exp [ - \frac{1}{2 {κ}^{2}} ( C - {b}^{T} {A}^{- 1} b ) ]\end{matrix} \qquad ( 37 )$$

### Step 4: Marginalize of the Variance Scale κ²

First, introduce an inverso-gamma prior on κ²,

$$Pr ( {κ}^{2} \vert α , β ) d {κ}^{2} = \frac{{β}^{α}}{Γ ( α )} {( {κ}^{2} )}^{- ( 1 + α )} exp [ - \frac{β}{{κ}^{2}} ] d {κ}^{2} . \qquad ( 38 )$$

Now form the joint probability distribution,

$$\begin{matrix}Pr ( \{ {x}_{ijk} \} , {κ}^{2} \vert α , β \{ {δμ}_{0 i} \} , γ , {v}_{0} , η , τ , σ ) d {κ}^{2} = {γ}^{- I} det {{( A )}^{- \frac{1}{2}} [ W {η}^{2} + 1 ]}^{- \frac{1}{2}} \\ {[ {\prod }_{k} ( \frac{{τ}^{2} {N}_{k} + {σ}^{2}}{{σ}^{2}} ) ]}^{- \frac{1}{2}} \\ {( 2 π {σ}^{2} )}^{- \frac{N}{2}} \\ \frac{{β}^{α}}{Γ ( α )} {( {κ}^{2} )}^{- ( 1 + α + \frac{N}{2} )} \\ exp [ - \frac{β + \frac{1}{2} ( C - {b}^{T} {A}^{- 1} b )}{{κ}^{2}} ] d {κ}^{2} .\end{matrix} \qquad ( 39 )$$

Finally, marginalise out κ²,

$$\begin{matrix}Pr ( \{ {x}_{ijk} \} \vert α , β \{ {δμ}_{0 i} \} , γ , {v}_{0} , η , τ , σ ) = {γ}^{- I} det {{( A )}^{- \frac{1}{2}} [ W {η}^{2} + 1 ]}^{- \frac{1}{2}} \\ {[ {\prod }_{k} ( \frac{{τ}^{2} {N}_{k} + {σ}^{2}}{{σ}^{2}} ) ]}^{- \frac{1}{2}} \\ {( 2 π {σ}^{2} )}^{- \frac{N}{2}} \\ \frac{{β}^{α}}{Γ ( α )} \frac{Γ ( {α}^{′} )}{{β}^{{′α}^{′}}} ,\end{matrix} \qquad ( 40 )$$

$$where$$

$${α}^{′} = α + \frac{N}{2} \qquad ( 41 )$$

$$and$$

$${β}^{′} = β + \frac{1}{2} ( C - {b}^{T} {A}^{- 1} b ) . \qquad ( 42 )$$

### Distance

Working backwards through equations 34 & 35 to provide central estimates of the δμᵢ through A⁻¹b, equation 19 to provide a central estimate of the global position v, and equation 14 to provide central estimates of the sample positions μₖ, we can revert to equation 13 to calculate its exponent. We also need an estimate of the variance scale κ²: the mode

$${κ}^{2} = \frac{{β}^{′}}{{α}^{′} + 1}$$

is always available but perhaps better is the reciprocal of κ⁻² which is simply

$$\frac{{β}^{′}}{{α}^{′}} .$$

The squared distances are accumulated and averaged over the MCMC run.

The variance of the estimated parameter in each MCMC iteration may be calculated as follows:

### Step 1: Marginalize Out v

The marginalization of parameters may be done in any convenient order. In this case we seek covariances between the μₖ and δμᵢ, so it is convenient to remove v first. Also, as we seek only the covariance structure, we need only consider what happens in the exponent. Ignoring κ² for the moment, and denoting the exponent f (v, μ, δμ),

$$2 f ( v , μ , δμ ) = \frac{{( v - {v}_{0} )}^{2}}{{η}^{2}} + {{\sum }^{K}}_{k} \frac{{( {μ}_{k} - v )}^{2}}{{τ}^{2}} + {{\prod }^{T}}_{i} \frac{( {δμ}_{i} - {δμ}_{i 0} )}{{σ}^{2}} + {\prod }_{ijk ∈ ON} \frac{{( {x}_{ijk} - {μ}_{k} - {δμ}_{i} )}^{2}}{{σ}^{2}} . \qquad ( 43 )$$

### Marginalising Out v Leaves

$$2 g ( μ , δμ ) = \frac{{v}_{0}}{{η}^{2}} + \frac{{\sum }_{k}^{K} {μ}_{k}^{2}}{{τ}^{2}} - {\frac{( {τ}^{2} {v}_{0} + {η}^{2} {\sum }_{k}^{K} {μ}_{k} )}{( {τ}^{2} + {η}^{2} K ) {η}^{2} {τ}^{2}}}^{2} + {{\prod }^{t}}_{i} \frac{{( {δμ}_{i} - {δμ}_{i 0} )}^{2}}{{γ}^{2}} + {\prod }_{ijk ∈ ON} \frac{{( {x}_{ijk} - {μ}_{k} - {δμ}_{i} )}^{2}}{{σ}^{2}} . \qquad ( 44 )$$

### Step 2: Take the Second Derivatives of g (μ, δμ)

The Hessian matrix for particular i, k is

$$H = [ \text{} \begin{matrix}\frac{{\partial }^{2} g}{\partial {δμ}_{i}^{2}} & \frac{{\partial }^{2} g}{\partial {δμ}_{i} \partial {μ}_{k}} \\ \frac{{\partial }^{2} g}{\partial {δμ}_{i} \partial {μ}_{k}} & \frac{{\partial }^{2} g}{\partial {μ}_{k}^{2}}\end{matrix} ] = [ \text{} \begin{matrix}{γ}^{- 2} + {N}_{i} {σ}^{- 2} & {N}_{ik} {σ}^{2} \\ {N}_{ik} {σ}^{- 2} & {τ}^{- 2} ( 1 - \frac{{η}^{2}}{{τ}^{2} + {η}^{2} K} ) + {N}_{k} {σ}^{- 2}\end{matrix} ] . \qquad ( 45 )$$

This allows us to construct a model for particular i, k around the central estimates of δμᵢ, μₖ already obtained. Dropping subscripts i, k,

$$Pr ( δμ , μ ) ∝ exp [ - \frac{1}{2} h ( δμ , μ ) ] \qquad ( 46 )$$

$$where$$

$$h ( δμ , μ ) = [ δμ - \hat{δμ} μ - \hat{μ} ] H [ \begin{matrix}δμ - \hat{δμ} \\ μ - \dot{μ}\end{matrix} ] . \qquad ( 47 )$$

### Step 3: Marginalize Out δμ and μ

We may replace either δμ or μ in terms of the other as they are constrained by μ+δμ=x. We then proceed to marginalize out the remaining variable leaving,

$$\begin{matrix}r ( x ) = {\hat{δμ}}^{2} {H}_{11} - 2 {\hat{δμ} ( x - μ )}^{2} {H}_{22} \\ - \frac{{\hat{[ δμ} ( {H}_{11} - {H}_{12} ) + ( x - \hat{μ} ) ( {H}_{22} - {H}_{12} ) ]}^{2}}{{H}_{11} + {H}_{22} - 2 {H}_{12}}\end{matrix} \qquad ( 48 )$$

### Step 4: Take Second Derivative of τ(x)

Taking the second derivative of r(x) yields the reciprocal of the variance in x,

$$Var [ x ] = \frac{{H}_{11} + {H}_{22} - 2 {H}_{12}}{det ( H )} . \qquad ( 49 )$$

### Step 5: Final Adjustments

Although we may be concerned with a measurement that has been used in the current parameter estimates, we always include measurement error by adding σ² to the variance obtained above.
Finally, the variance is scaled by the current estimate of κ², so that the square of the distance in the current MCMC iteration is

$${d}^{2} ( x ) = \frac{{( x - \hat{μ} - \hat{δμ} )}^{2}}{{κ}^{2} ( Var [ x ] + {σ}^{2} )} . \qquad ( 50 )$$

### Quantity Measurements

### Prior Probability Distributions

We will assume a normal distribution for the compound quantities λᵢ with mean Λᵢ and variance ρ² (scaled by κ²),

### Ion Areas and Ratios

It might be appropriate to have common ion ratios associated with an analyte compound and its internal standard if the internal standard is an isotopically labelled version of the analyte compound, but in the general case each compound would be associated only with its own ion ratios. To accommodate either option we use a subscript l to denote a group of compounds expected to have the same underlying ion ratios among their transitions, and i indicates a single compound within the l^{th} group (usually containing a single compound or a compound/internal standard pair).

The overall scale of ion areas is taken to be log-normally distributed with each compound having its own parameters for the distribution. We may, therefore, assume a normal prior in log quantity λᵢₖ over range Λ. Working in terms of log area, aᵢⱼₖ for a particular transition j and compound i in a particular compound group l and sample k,

$$Pr ( \{ {a}_{ijk} \} , \{ {λ}_{ik} \} \vert i ∈ l , k , Λ , κ , \{ {ϕ}_{lj} \} ) = [ {\prod }_{i} {( 2 π {ρ}_{i}^{2} {κ}^{2} )}^{- \frac{1}{2}} ] {( 2 π {σ}^{2} {κ}^{2} )}^{- \frac{{N}_{ik}}{2}} exp [ - \frac{1}{2 {κ}^{2}} ( {\sum }_{i} \frac{{( {λ}_{i} - {Λ}_{i} )}^{2}}{{ρ}_{i}^{2}} + {\prod }_{j} \frac{{( {a}_{ijk} - {λ}_{ik} - {ϕ}_{lj} )}^{2}}{{σ}^{2}} ) ] . \qquad ( 52 )$$

The ϕₗⱼ≤0 may be thought of as the logarithm of the efficiency of the j^{th} transition of the l^{th} compound group. Letting a′ᵢⱼₖ=aᵢⱼₖ₋−ϕₗⱼ and rearranging the inner sum in the exponent,

$$\begin{matrix}\frac{{( {λ}_{i} - {Λ}_{i} )}^{2}}{{ρ}_{i}^{2}} + {\sum }_{j} \frac{{( {a}_{ijk} - {λ}_{ik} - {ϕ}_{lj} )}^{2}}{{σ}^{2}} = ( {σ}^{- 2} {N}_{ik} + {ρ}_{i}^{- 2} ) {( {λ}_{ik} - \frac{{σ}^{- 2} {\sum }_{j} {a}_{ijk}^{′} + {ρ}_{i}^{- 2} {Λ}_{i}}{{σ}^{- 2} {N}_{ik} + {ρ}_{i}^{- 2}} )}^{2} \\ - {( \frac{{σ}^{- 2} {\sum }_{j} {a}_{ijk}^{′} + {ρ}_{i}^{- 2} {Λ}_{i}}{{σ}^{- 2} {N}_{ik} + {ρ}_{i}^{- 2}} )}^{2} + {σ}^{- 2} {\sum }_{j} {a}_{ijk}^{′2} + {ρ}_{i}^{- 2} {Λ}_{i}^{2} \\ = ( {σ}^{- 2} {N}_{ik} + {ρ}_{i}^{- 2} ) {( {λ}_{ik} - \frac{{σ}^{- 2} {\sum }_{j} {a}_{ijk}^{′} + {ρ}_{i}^{- 2} {Λ}_{i}}{{σ}^{- 2} {N}_{ik} + {ρ}_{i}^{- 2}} )}^{2} \\ + \frac{{N}_{ik} [ {Var [ {a}_{ijk}^{′} ]}_{ik} ( {σ}^{- 2} {ρ}_{i}^{2} + 1 ) + {( {\overline{a}}_{ik}^{′} - {Λ}_{i} )}^{2} ]}{{ρ}_{i}^{2} {N}_{ik} + {σ}^{2}}\end{matrix}$$

Marginalising out the λᵢₖ for all i∈l yields,

$$Pr ( \{ {a}_{ijk} \} \vert i ∈ l , k , Λ , κ , \{ {ϕ}_{lj} \} ) = {[ {\prod }_{i ∈ l} \frac{{ρ}_{i}^{2} {N}_{ik} + {σ}^{2}}{{σ}^{2}} ]}^{- \frac{1}{2}} {( 2 π {σ}^{2} {κ}^{2} )}^{- \frac{{N}_{ik}}{2}} exp [ - \frac{1}{2 {κ}^{2}} {\sum }_{i} \frac{{N}_{ik} [ {Var [ {a}_{ijk}^{′} ]}_{ik} ( {σ}^{- 2} {ρ}_{i}^{2} + 1 ) + {( \overline{{a}_{ik}^{′}} - {Λ}_{i} )}^{2} ]}{{ρ}_{i}^{2} {N}_{ik} + {σ}^{2}} ] . \qquad ( 54 )$$

We can again marginalise out the variance scale κ², under a suitable prior, to leave the ϕₗⱼ to be explored by MCMC.

### Distance

To calculate distances (squared) of the area measurements from the central estimate of the model for the current MCMC iteration, we need only estimate the λᵢₖ, as current samples of the ϕₗⱼ are provided, along with κ². The estimates of λᵢₖ are made according to equation 53 as

$${\hat{λ}}_{ik} = \frac{{ρ}_{f}^{2} {N}_{ik} {a}_{ik}^{′} + {σ}^{2} {Λ}_{i}}{{ρ}_{i}^{2} {N}_{ik} + {σ}^{2}} , \qquad ( 55 )$$

with variances

$$Var [ {\hat{λ}}_{ik} ] = \frac{{σ}^{2} {ρ}_{i}^{2}}{{ρ}_{i}^{2} {N}_{ik} + {σ}^{2}} . \qquad ( 56 )$$

As for the positional measurements, an addition of σ² is made to account for measurement error before scaling by the current estimate of κ², so that the square of the distance in the current MCMC iteration is

$${d}^{2} ( a ) = \frac{{( a - \hat{λ} - ϕ )}^{2}}{{κ}^{2} ( Var [ \hat{λ} ] + {σ}^{2} )} . \qquad ( 57 )$$

### MCMC Exploration of ON/OFF States

The analysis above applies to all those measurements assumed to be in the ON group, but membership of that group remains to be explored. Prior probabilities of belonging to the ON group could be broken down in terms of sample type and compound type (analyte or internal standard) and transition type (Quantifier, Qualifier). For full generality, we will use individual pᵢₖ for each transitions in the k^{th} sample. Let M be the total number of chromatograms with N the number assigned to the ON group and M−−N assigned to the OFF group. The likelihood for the measurement of a particular field f in the OFF group is

$$Pr ( {f}_{ijk} \vert OFF ) = {Δ}_{f}^{- 1} , \qquad ( 58 )$$

$$so$$

$$\begin{matrix}Pr ( \{ {z}_{ijk} \} \vert α , β , γ , Δ , τ ) = [ {\prod }_{ijk ∈ OFF} ( 1 - {p}_{ijk} ) ] {\prod }_{f} {Δ}_{f}^{N - M} \\ [ {\prod }_{ijk ∈ ON} {p}_{ijk} ] {\prod }_{f} Pr ( \{ {f}_{ijk} \} \vert ijk ∈ ON ) .\end{matrix}$$

We can associate switch states with each transition and explore the configuration of switches using MCMC.

### Example 1: Ranking Chromatograms: Therapeutic Drug Monitoring (Absolute Determination)

In another example, the present technology quantifies and/or classifies absolute amounts of one or more therapeutic drugs as a method of therapeutic drug monitoring. For example, everolimus is a commonly used immunosuppressive agent with a variety of active mechanisms such as high inter- and intra-individual variability. Therefore, an accurate, analytically sensitive quantitative method using the present technology may play a role in researching the pharmacokinetic and pharmacodynamic effects of administration.

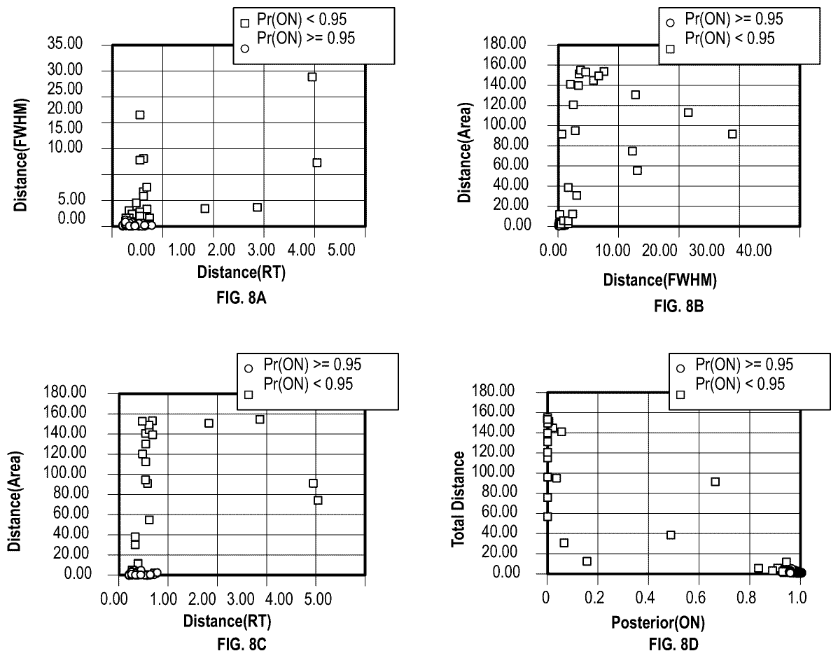

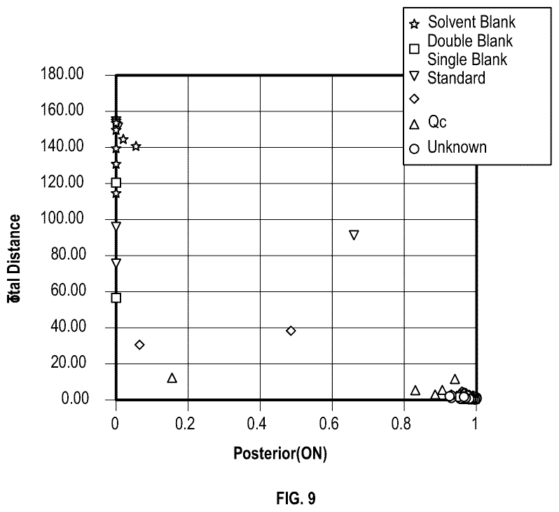

Here, the present technology applies a learning model of the present technology that is optimized by determining value(s) for therapeutic drug monitoring, including bias values that may influence measurement of hematocrit. The method of the present technology uses an LC-MS/MS instrument for the analysis of dried blood spot analysis of everolimus. The everolimus sample is analyzed by using peak detection, quantifying consistency, and applying the learning model based on the methods disclosed herein in order determine a value (e.g., a concentration or amount) for everolimus in the sample. This information could be used for therapeutic drug monitoring. Likewise, calculated bias values on medical decision levels showed that there was no clinical influence of hematocrit on the results. FIGS. 8 and 9 show the result of processing a batch of everolimus samples using the technique described. The batch of 36 samples included 4 solvent blanks, 1 double blank and 2 single blanks.

FIG. 8A depicts the area distance versus retention time distance. FIG. 8B depicts the area distance versus peak FWHM distance. FIG. 8C depicts the peak FWHM distance versus retention time distance. FIG. 8D depicts a total distance versus posterior probability (Pr) of a peak being in the ON set. Those peaks with Pr(ON)≥0.95 are colored yellow, the remainder are colored blue. FIG. 9 is a repeat of FIG. 8D, with the different sample types indicated.

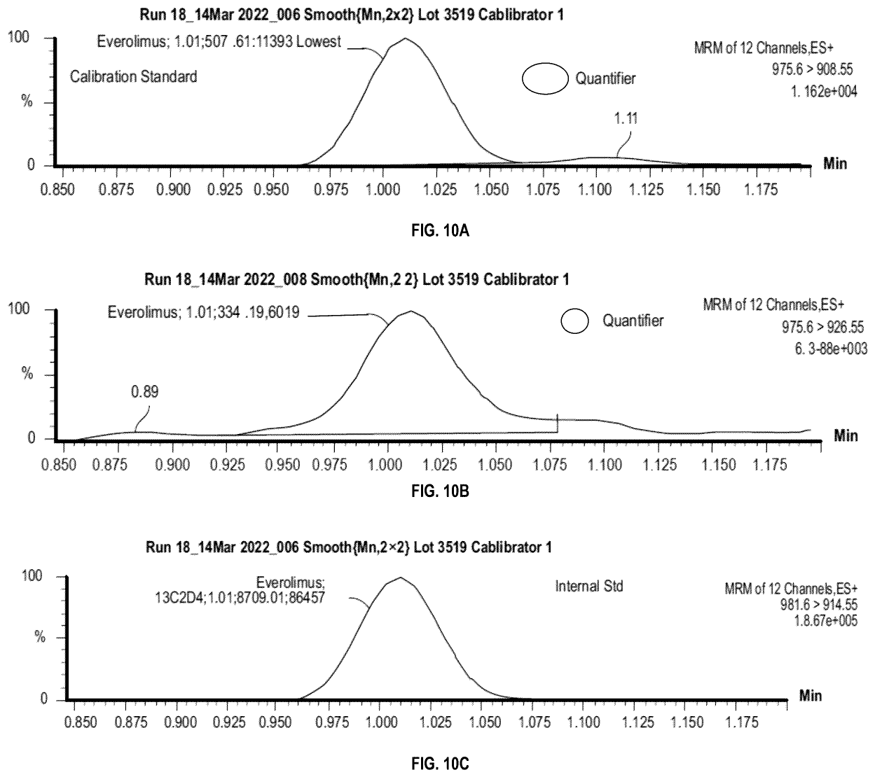

The chromatograms for standard peaks indicated in FIG. 9 as shown in FIG. 10. A first standard peak chromatogram is shown in FIG. 10A (circled data point in FIG. 9). A second standard peak chromatogram is shown in FIG. 10B (ellipse encircled data point in FIG. 9). An internal standard chromatogram is shown in FIG. 10C. The presence of a significant baseline appears to have affected the ratio of areas between the quantifier and qualifier peaks which is 1.82 compared with an overall estimate of 2.24, leading to high area distances of 38 and 30 for the quantifier and qualifier, respectively.

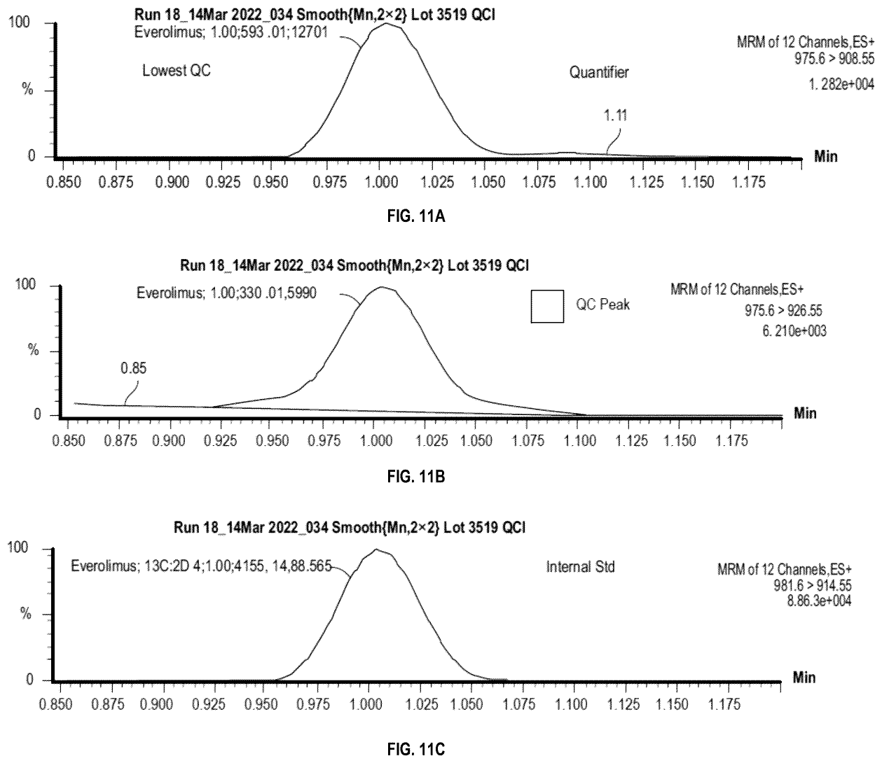

The chromatogram for the QC peak in FIG. 9 (square box) is shown in FIG. 11B between a quantifier chromatogram (FIG. 11A) and an internal standard chromatogram (FIG. 11C). In this case it is the peak width of the qualifier (0.0473 minutes) that is somewhat wider than the overall estimate (0.0449 minutes), leading to a FWHM distance of 12 for peak area.

Table 6 gives the posterior probabilities and distances associated with the 40 chromatographic peaks with highest Total Distances, listed in descending order of Total Distance. This is not quite equivalent to ranking the peaks in ascending order of posterior probability, as shown in FIGS. 8 and 9, because: (a) The posterior probabilities are simply the proportion of times the peak was in the ON group over the MCMC run of 200 iterations, so there statistical variations in the estimation of the posterior probabilities; and (b) When a peak is in the OFF group it loses connection with the various parameters describing the expected retention time, peak width and area. This can produce large contributions to the overall distance particularly from the area measurement which has the most variability.

TABLE 6

| Injection | | | | | | | | Total |
|---|---|---|---|---|---|---|---|---|
| Name | Sample Type | Compound Type | Ion | Posterior | Distance(RT) | Distance(FWHM) | Distance(AREA) | Distance |
| Run 18_002 | Solvent blank | Analyte | 0 | 0 | 2.86 | 3.68 | 154.88 | 154.95 |
| Run 18_001 | Solvent blank | Internal standard | 0 | 0 | 0.68 | 7.57 | 153.52 | 153.70 |
| Run 18_003 | Solvent blank | Internal standard | 0 | 0 | 0.47 | 4.54 | 152.98 | 153.05 |
| Run 18_012 | Single blank | Analyte | 0 | 0.005 | 1.83 | 3.44 | 151.06 | 151.11 |
| Run 18_003 | Solvent blank | Analyte | 0 | 0 | 0.61 | 6.70 | 149.18 | 149.33 |
| Run 18_001 | Solvent blank | Analyte | 0 | 0.02 | 0.61 | 5.82 | 144.63 | 144.75 |
| Run 18_001 | Solvent blank | Analyte | 1 | 0.055 | 0.54 | 2.00 | 140.85 | 140.86 |
| Run 18_002 | Solvent blank | Internal standard | 0 | 0 | 0.68 | 3.35 | 139.62 | 139.67 |
| Run 18_002 | Solvent blank | Analyte | 1 | 0 | 0.54 | 12.79 | 130.38 | 131.01 |
| Run 18_004 | Double blank | Internal standard | 0 | 0 | 0.48 | 2.50 | 120.47 | 120.49 |
| Run 18_003 | Solvent blank | Analyte | 1 | 0 | 0.54 | 21.53 | 112.78 | 114.82 |
| Run 18_012 | Single blank | Analyte | 1 | 0 | 3.95 | 28.85 | 91.39 | 95.92 |
| Run 18_004 | Double blank | Analyte | 0 | 0.035 | 0.54 | 2.81 | 94.81 | 94.86 |
| Run 18_005 | Single blank | Analyte | 0 | 0.66 | 0.58 | 0.62 | 91.31 | 91.31 |
| Run 18_005 | Single blank | Analyte | 1 | 0 | 4.05 | 12.29 | 74.48 | 75.60 |
| Run 18_004 | Double blank | Analyte | 1 | 0 | 0.61 | 13.10 | 55.09 | 56.63 |
| Run 18_006 | Standard | Analyte | 0 | 0.485 | 0.33 | 1.66 | 38.29 | 38.33 |
| Run 18_006 | Standard | Analyte | 1 | 0.065 | 0.33 | 3.05 | 30.42 | 30.58 |
| Run 18_034 | QC | Analyte | 1 | 0.155 | 0.39 | 2.38 | 12.00 | 12.24 |
| Run 18_034 | QC | Analyte | 0 | 0.94 | 0.39 | 0.23 | 11.63 | 11.64 |
| Run 18_013 | QC | Analyte | 0 | 0.905 | 0.27 | 0.86 | 5.46 | 5.53 |
| Run 18_013 | QC | Analyte | 1 | 0.83 | 0.27 | 1.66 | 5.17 | 5.44 |
| Run 18_005 | Single blank | Internal standard | 0 | 0.96 | 0.45 | 0.15 | 5.10 | 5.12 |
| Run 18_011 | Standard | Analyte | 0 | 0.965 | 0.26 | 0.83 | 4.00 | 4.09 |
| Run 18_011 | Standard | Analyte | 1 | 0.97 | 0.26 | 0.40 | 3.85 | 3.88 |
| Run 18_008 | Standard | Internal standard | 0 | 0.965 | 0.38 | 0.26 | 3.74 | 3.76 |
| Run 18_009 | Standard | Analyte | 1 | 0.955 | 0.26 | 0.50 | 3.21 | 3.26 |
| Run 18_035 | QC | Analyte | 1 | 0.885 | 0.73 | 1.66 | 2.41 | 3.01 |
| Run 18_010 | Standard | Analyte | 0 | 0.93 | 0.26 | 0.32 | 2.97 | 3.00 |
| Run 18_010 | Standard | Analyte | 1 | 0.965 | 0.26 | 0.07 | 2.87 | 2.88 |
| Run 18_007 | Standard | Internal standard | 0 | 0.98 | 0.77 | 0.20 | 2.73 | 2.85 |
| Run 18_009 | Standard | Analyte | 0 | 0.97 | 0.26 | 0.22 | 2.80 | 2.82 |
| Run 18_020 | Unknown | Analyte | 0 | 0.93 | 0.26 | 0.98 | 2.29 | 2.50 |
| Run 18_006 | Standard | Internal standard | 0 | 0.99 | 0.46 | 0.24 | 2.41 | 2.46 |
| Run 18_035 | QC | Analyte | 0 | 0.98 | 0.43 | 0.76 | 2.24 | 2.40 |
| Run 18_032 | Unknown | Analyte | 1 | 0.975 | 0.33 | 1.07 | 2.05 | 2.33 |
| Run 18_036 | QC | Analyte | 1 | 0.945 | 0.72 | 0.48 | 2.14 | 2.31 |
| Run 18_010 | Standard | Internal standard | 0 | 0.98 | 0.40 | 0.26 | 2.26 | 2.31 |
| Run 18_036 | QC | Analyte | 0 | 0.975 | 0.44 | 0.64 | 2.05 | 2.20 |
| Run 18_015 | QC | Analyte | 0 | 0.955 | 0.33 | 0.65 | 2.04 | 2.16 |

Although the present technology has been described with reference to preferred embodiments, it will be understood by those skilled in the art that various changes in form and detail may be made without departing from the scope of the present invention as set forth in the accompanying claims.

What is claimed is:

1. A chromatographic instrument for quantifying analytes comprising:
a processing device for executing computer readable instructions for performing a method of quantifying analytes, the method comprising:
collecting chromatograms of one or more analytes of one or more samples;
determining statistical distances with respect to a consensus data distribution for chromatographic peak features or MRM transition data in the collected chromatograms; and
ranking each chromatogram based on the determined statistical distances.

2. The instrument of claim 1, wherein the statistical distances comprise one or more of: retention time (RT) distance with respect to a RT consensus data distribution; full width, half maximum (FWHM) distance with respect to a FWHM consensus data distribution; peak area (PA) distance with respect to a PA consensus data distribution; peak asymmetry (ASYM) distance with respect to a ASYM consensus data distribution; and peak height (PH) distance with respect to a PH consensus data distribution.

3. The instrument of claim 2, wherein the collected chromatograms are ranked based on a mathematical combination of a plurality of the statistical distances.

4. The instrument of claim 2, further comprising ordering the chromatograms sequentially, starting with the highest ranked chromatogram, wherein the highest ranked chromatogram has the highest statistical distance or the highest mathematical combination of the statistical distances.

5. The instrument of claim 1, wherein the statistical distances are calculated using a Markov Chain Monte Carlo (“MCMC”) method.

6. The instrument of claim 1, wherein raw chromatographic data of the collected chromatograms are collected from a plurality of analytes that are run simultaneously or sequentially.

7. The instrument of claim 6, wherein the raw chromatographic data includes retention times and relative abundances.

8. The instrument of claim 1, wherein the one or more samples comprise of endogenous or isotopically labeled analytes.

9. The instrument of claim 1, wherein the instrument is a liquid chromatography instrument.

10. The instrument of claim 1, wherein the instrument is a mass spectrometer.

11. The instrument of claim 1, wherein the instrument is a liquid chromatography-mass spectrometer.

12. A method of quantifying sample data from a chromatographic instrument comprising:
collecting chromatograms of one or more analytes of one or more samples;
determining statistical distances from a consensus data distribution for chromatographic peak features or MRM transition data in the collected chromatograms; and
ranking each chromatogram based on the determined statistical distances.

13. The method of claim 12, wherein the statistical distances comprise one or more of: retention time (RT) distance with respect to a RT consensus data distribution; full width, half maximum (FWHM) distance with respect to a FWHM consensus data distribution; peak area (PA) distance with respect to a PA consensus data distribution; peak asymmetry (ASYM) distance with respect to a ASYM consensus data distribution; and peak height (PH) distance with respect to a PH consensus data distribution.

14. The method of claim 13, wherein the collected chromatograms are ranked based on a mathematical combination of a plurality of the statistical distances.

15. The method of claim 13, further comprising ordering the chromatograms sequentially, starting with the highest ranked chromatogram, wherein the highest ranked chromatogram has the highest statistical distance or the highest mathematical combination of the statistical distances.

16. The method of claim 15, further comprising reviewing the ordered chromatograms sequentially, starting with the highest ranked chromatogram.

17. The method of claim 12, wherein the statistical distances are calculated using a Markov Chain Monte Carlo (“MCMC”) method.

18. The method of claim 12, wherein raw chromatographic data of the collected chromatograms is collected from a plurality of analytes that are run simultaneously or sequentially.

19. The method of claim 18, wherein the raw chromatographic data of the collected chromatograms includes retention times and relative abundances.

20. The method of claim 12, wherein the one or more samples comprise of endogenous and isotopically labeled analytes.
